(19) United States
(12) Patent Application Publication
(10) Pub. No.: US 2004/0158823 A1
(43) Pub. Date: Aug. 12, 2004

(54) Method, apparatus and system for generating customized UPnP applications

(76) Inventors: Ylian Saint-Hilaire, Hillsboro, OR (US); Bryan Y. Roe, Camas, WA (US); Nelson F. Kidd, Tigard, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/365,230

(22) Filed: Feb. 12, 2003

(51) Int. Cl. G06F 9/45

(52) U.S. Cl. 717/140; 717/151; 717/106

(57) ABSTRACT

Customized Universal Plug and Play (“UPnP”) device applications may be generated. According to one embodiment, a variety of device-specific information (e.g., device and service descriptions) and platform information may be used to generate source code for a UPnP device. The source code may be optimized and/or type checked for the device. The source code may then be compiled with interface information to generate the customized UPnP application.

### FIELD OF THE INVENTION

The present invention relates to the field of networking, and, more particularly to a method, apparatus and system for automatically generating compact and efficient Universal Plug and Play (“UPnP”) device applications.

### BACKGROUND

Universal Plug and Play (“UPnP”) provides an architecture for peer-to-peer network connectivity. UPnP-compliant devices may dynamically join a network, obtain a network address, convey their capabilities to the network and learn about the presence and capabilities of other devices on the network. UPnP devices may then communicate with each other directly (i.e., in a peer-to-peer mode). The UPnP Forum (“UPnP Forum”) is an industry initiative tasked with developing standards for describing device protocols that enable device-to-device interoperability. The UPnP Forum is divided into working committees responsible for promulgating Device Architectures (“templates”) for specific device standards.

In order to build UPnP compliant devices, device vendors today typically acquire (e.g., purchase) generic prepackaged UPnP stacks and build device specific portions of code on top of the generic stacks (these device stacks, including the generic prepackaged UPnP stack, are hereafter referred to as “Device Stacks”). The concept of “stacks” is well known to those of ordinary skill in the art and further description thereof is omitted herein. Device stacks today are likely to be written using a relatively complex Extensible Markup Language (“XML”) parser. An “XML Parser” is a code module capable of encoding and decoding XML. XML is a World Wide Web Consortium (“WC3”) promulgated standard markup language that allows users to generate tags for their files. The tags enable computers (and humans) to interpret the contents of the file.

UPnP Device Stacks are likely to be large because they are built on generic UPnP stacks that include significant amounts of unnecessary code for a specific device type. For example, a generic UPnP stack may include features usable by Devices A, B and C, but a device vendor may only require a subset of the features for a particular device (e.g., Device A). The device vendor nonetheless includes all the features when building the Device Stack because the generic stack must include all possible features. Additionally, a generic Device Stack today is likely to include a fully featured, and rather large, XML parser to interpret XML tags. Inclusion of the XML parser in the Device Stack further increases the size and complexity of the stack.

### BRIEF DESCRIPTION OF THE DRAWINGS

The present invention is illustrated by way of example and not limitation in the figures of the accompanying drawings in which like references indicate similar elements, and in which:

FIG. 1 illustrates conceptually the protocol stack currently used by UPnP-compliant devices;

FIG. 2 illustrates a conceptual representation of an embodiment of the present invention;

FIG. 3 is a flow chart illustrating an embodiment of the present invention in further detail; and

FIGS. 4-7 illustrate by way of example a series of sample user interfaces that may be used to implement an embodiment of the present invention.

### DETAILED DESCRIPTION

Embodiments of the present invention describe a method, apparatus and system for generating customized UPnP device applications. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same.

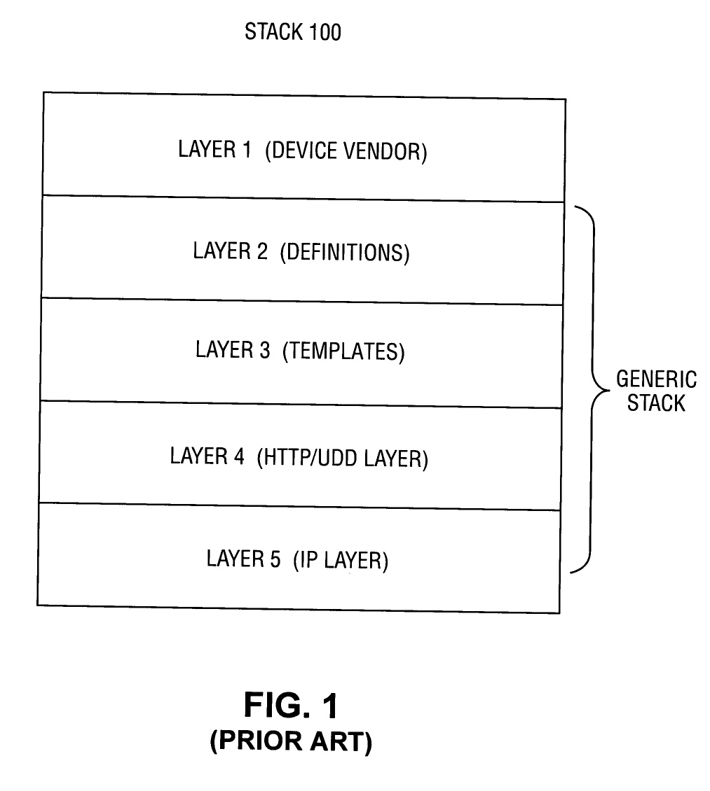

FIG. 1 illustrates conceptually the protocol stack (“Stack 100”) currently used by UPnP-compliant devices. As illustrated, the highest level (Layer 1) is the UPnP Vendor Layer that may be added on by UPnP device vendors to customize generic stacks for specific devices. Layers 2-5 comprise the generic protocol stack. Layer 2 includes all the information defined by the UPnP Forum working committee for each UPnP device. The UPnP Device Architecture layer (Layer 3) includes various templates from the UPnP Forum for creating device and service descriptions for any device and/or service type. These templates may be used by UPnP vendors to write device and service descriptions, and include a list of commands or actions the device and/or service responds to, and parameters or arguments for each device and/or action. A service description may also include a list of variables that model the state of the service at run time. UPnP-compliant messages are delivered via Hyper Text Transport Protocol (“HTTP”) or User Datagram Protocol (“UDP”) (both in Layer 4), all running over Internet Protocol (“IP”) (Layer 5).

The protocol layers illustrated in FIG. 1 are used during the various phases of UPnP networking. UPnP networking includes the following phases: a discovery phase, a description phase, a control phase, an eventing phase and a presentation phase. During the discovery phase, any UPnP compliant device added to a network may advertise its services to controllers (“control points”) on the network and search for other devices of interest on the network. The UPnP discovery protocol is based on the Simple Service Discovery Protocol (“SSDP”).

In the description phase, control points on the network may retrieve device and service descriptions from the URLs provided by each device on the network. During the control phase, control points may send actions to a device's service by sending a control message via Simple Object Access Protocol (“SOAP”) to the control URL for the service (provided in the device description). The eventing phase is used by devices on the network to send out updates (“event messages”) to their services. Finally, if a device has a URL for presentation, then during the presentation phase, a control point may control the device and/or view the device status.

According to one embodiment of the present invention, instead of purchasing generic stacks and creating Device Stacks, device vendors may instead generate a customized UPnP device application (hereafter referred to as “Custom App”) for each device. A Custom App may be tailored for specific devices, thus avoiding the unnecessary code found in a Device Stack today. As a result, a Custom App may be significantly smaller and more efficient than a Device Stack. Custom Apps may additionally be optimized for the various phases of UPnP networking.

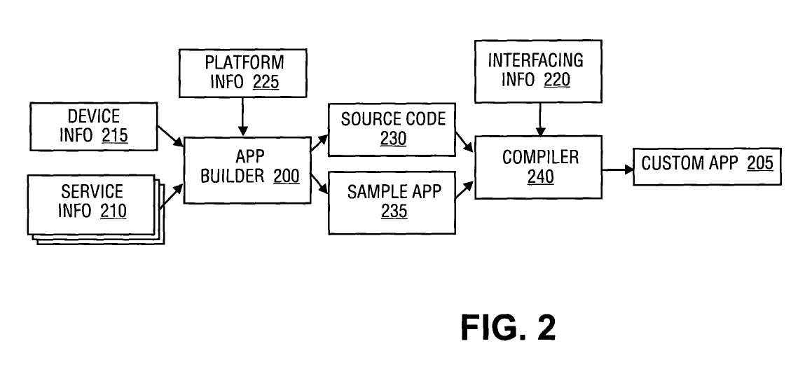

An embodiment of the present invention is presented conceptually in FIG. 2. A device vendor may provide various information to a Custom App generator (hereafter “App Builder 200”) that generates Custom App 205 for each device. More specifically, according to embodiments of the present invention, the following information may be provided to App Builder 200: (i) the services file that describes the services, actions and events offered by the UPnP device (collectively “Service Information 210”); (ii) the devices file that describes vendor-specific information such as the model name and number of the device(s), serial number(s) and manufacturer name(s) (collectively “Device Information 215”); (iii) interfacing information such as threading model, method prefixes and fragmented response (“Interfacing Information 220”); and (iv) platform information such as operating system, allowed data types and target compiler (“Platform Information 225”).

According to one embodiment, App Builder 200 may utilize Service Information 210, Device Information 215 and Platform Information 225 to generate source code for Custom App 205 (“Source Code 230”) for a given device. It will be readily apparent to those of ordinary skill in the art that App Builder 200 may be implemented in a number of different ways to generate Source Code 230 without departing from the spirit of embodiments of the present invention. In one embodiment, App Builder 200 may also generate a sample application (“Sample App 235”) based on Source Code 230. Sample App 235 may include the entire development environment necessary to generate Custom App 205, thus simplifying the process for device vendor's to generate custom applications for their devices. Alternatively, Source Code 230 may be integrated into the device vendor's own development environment. In either case, Complier 240 may then use Interfacing Information 220 and compile Source Code 230 and/or Sample App 235 to generate Custom App 205 for the device.

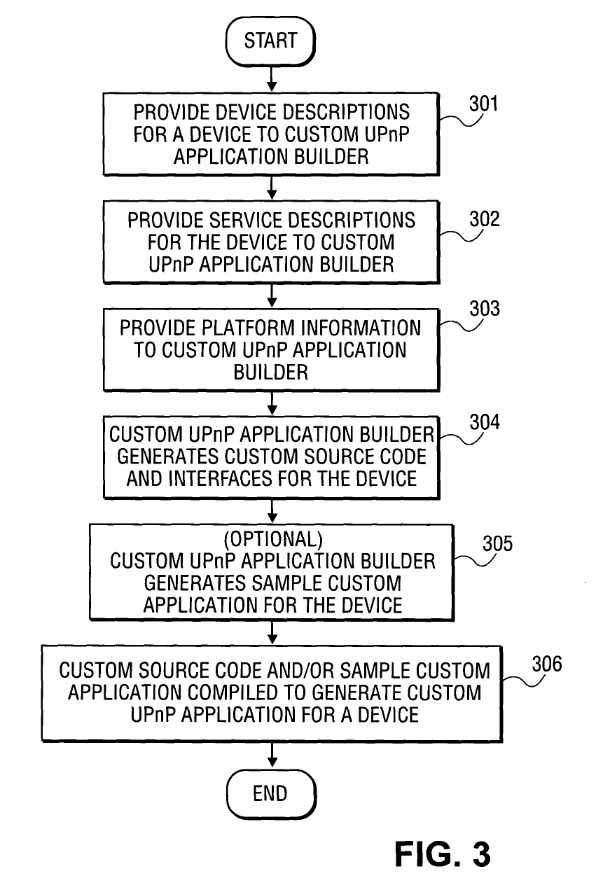

FIG. 3 is a flow chart illustrating this process in further detail. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention. As illustrated, in 301, device descriptions for a specific device are provided to the custom application builder (e.g., App Builder 200 in FIG. 2 above). In 302, service descriptions for the specific device are also provided to the custom application builder. Platform specific information may also be provided to the custom application builder in 303. Using the device and service descriptions and platform specific information, the custom application builder may generate custom source code and interfaces for the device in 304. Optionally, the custom application builder may generate a sample application for the device in 305. The custom source code and/or sample application may then be compiled in 306 to generate a custom application for the device. According to embodiments of the present invention, the custom application may be generated for any operating system (e.g., Windows, Unix, Linux, etc.) using any programming language (e.g., C, C++, C#, Java, Visual Basic, etc.).

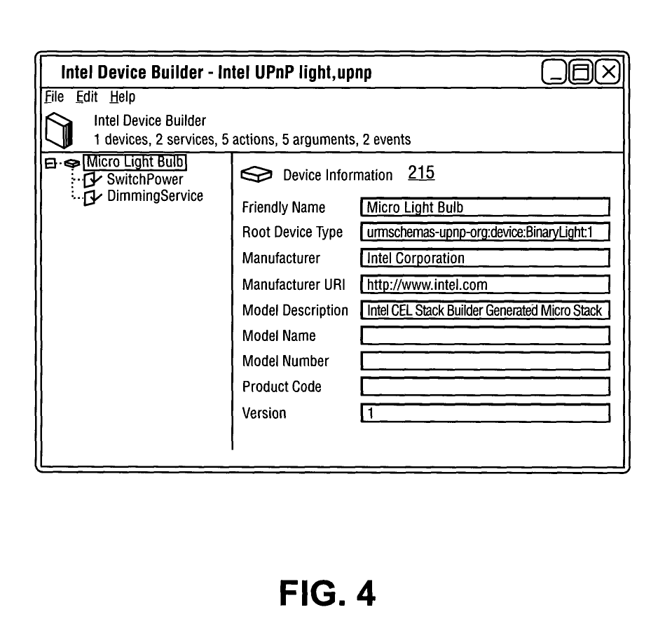

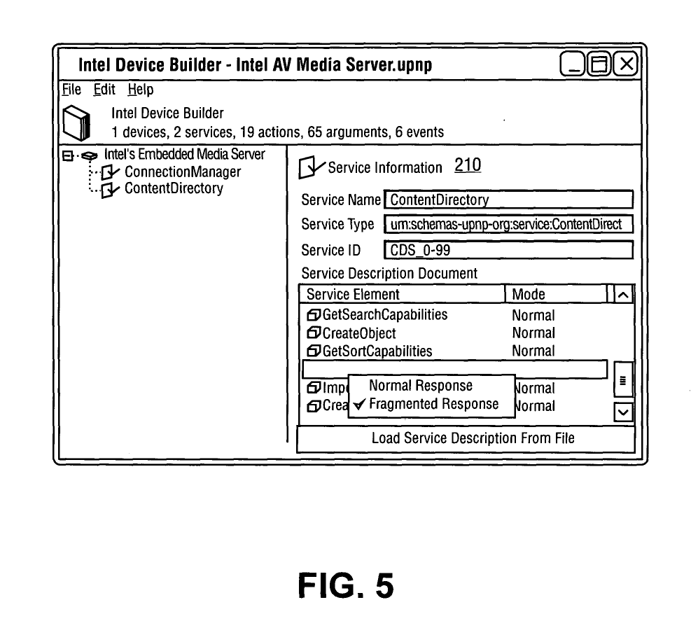

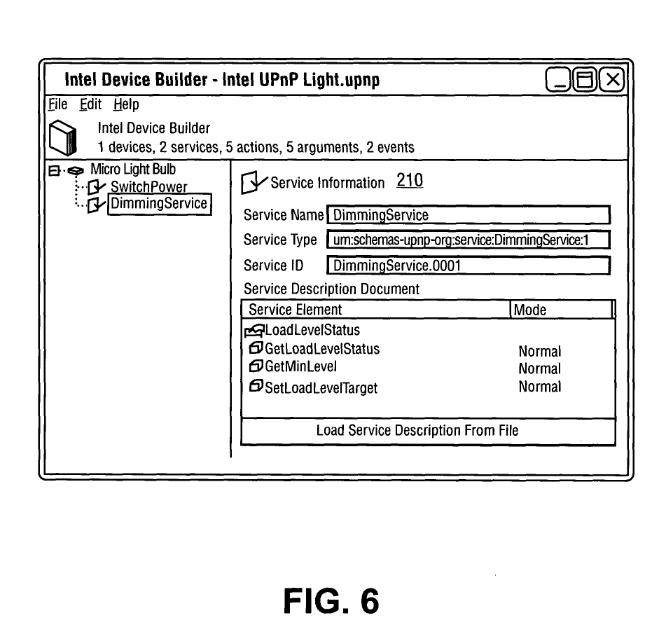

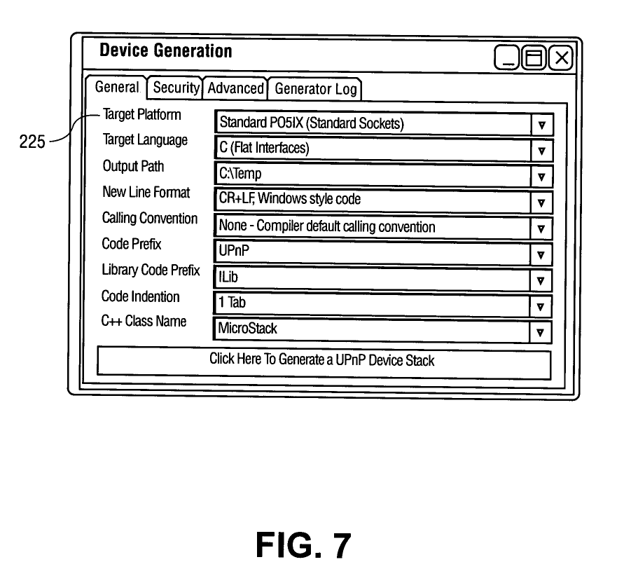

FIGS. 4-7 illustrate by way of example a series of sample user interface screens for an application builder that may be used to implement an embodiment of the present invention. It will once again be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention. As illustrated in FIG. 4, a device vendor may load device descriptions (Device Info 215) from a devices file. The vendor may also select one or more services files (Service Info 210) that may be used to load service descriptions for the device (illustrated in FIG. 5 and FIG. 6). In accordance with an embodiment of the present invention illustrated in FIG. 7, the device vendor may specify platform information (Platform Info 225), including compiler information, to generate custom code and a sample application for the device. The custom code and/or sample application may be compiled to generate a Custom App for the device.

According to embodiments of the present invention, Custom App may be optimized for various phases of UPnP networking. More specifically, since Custom App is completely self-contained, i.e., all information pertaining to a device is generally known ahead of time, this information may be incorporated into Custom App when the application is automatically generated. The following describes how commonly used UPnP network protocols are optimized in accordance with various embodiments of the present invention during the discovery, control, and eventing phases of UPnP.

During the discovery phase, devices may advertise their services to control points on the network, and control points may search for devices of interest on the network. In accordance with an embodiment of the present invention, the SSDP protocol (utilized during the discovery phase) may be optimized for both functions. Specifically, significant portions of the UDP packets from a device may be pre-encoded with information that is known in advance about the device. Subsequently at runtime, SSDP may use an sprintf( ) call to print the unique device identifier (“UDN”) and local IP address information contained within the device's UDP packets. Use of sprintf( ) is well known to those of ordinary skill in the art and further description of such is omitted herein in order not to unnecessarily obscure the present invention.

Similarly, in one embodiment, a set of well-known strings may be stored on the device, and when responding to SSDP search requests from control points, these search requests may be compared against these strings. A match may trigger transmission of a pre-encoded response associated with that string. For example, a service search will trigger a response with the corresponding service notification packet. This pre-encoded response enables a faster and more efficient response than the traditional method whereby Device Stacks generated responses from scratch.

During the control phase, control points may send control messages to devices (“outbound”) and devices may receive control messages from control points on the network (“inbound”). The inbound and outbound control messages, typically expressed in SOAP XML, may be optimized in accordance with embodiments of the present invention. Specifically, according to one embodiment, inbound HTTP packets expressed in SOAP XML may be decoded as follows. The inbound packet headers may be run through an in-place tokenizer, creating an array of pointers that separate each tag in the HTTP header. Use of in-place tokenizers is well known in the art and further description thereof is omitted herein. According to one embodiment of the present invention, Custom App may then search for specific entries in the header, e.g., request object, content length, etc.). The HTTP packet (containing SOAP XML) may also be run through an in-place tokenizer, and looping code may be used to look for specific XML tags within the packet. Failure to find an expected tag may cause the HTTP session to return an error and close.

According to one embodiment, once an HTTP packet containing SOAP XML is decoded, each input argument may be converted to a native system type and type checked at the same time. The resulting call and argument may be sent to a function generated by the developers of Custom App. These pre-defined functions may receive the inbound arguments and send back output arguments.

According to another embodiment of the present invention, outbound HTTP packets may be encoded using pre-generated SOAP XML responses that have missing arguments. As before, a call to sprintf( ) may quickly add the missing arguments into the response. According to one embodiment, to minimize code size, outbound arguments may not be type checked. In an alternate embodiment of the present invention, device vendors may be given the option to type check outbound arguments. The total size of the response may be calculated and an HTTP header may then be added to the outbound packet.

According to an embodiment, the eventing phase of UPnP may be handled similar to the SOAP events in the control phase. Specifically, the XML code for each event may be pre-generated and placed within the source code. In one embodiment, variables may be converted into XML string types before being sent over the network. The HTTP processor used to handle SOAP XML during the control phase may also handle subscribe and unsubscribe requests. Each evented state variable may be stored in a string format so it can be sent as part of the complete state to new event subscribers.

In accordance with one embodiment, various other optimizations may be implemented. For example, the SCPD (“Service Control Protocol Definition”) service description documents and device description documents used to generate the code may be statically embedded in the generated code. Additionally, service description documents are static and may be stored with HTTP headers pre-attached. In an embodiment, these service description documents may be stored in the most compact possible way, e.g., by removing extra spaces and carriage returns. Device information may also be statically embedded, except for the unique device identifier (“UDN”), which may be obtained at runtime from a parameterized string value. If the device information includes a “BaseURI” tag (i.e., a tag which indicates a specific IP address and path to obtain other documents), the BaseURI may also be filled in at runtime.

Most Generic Stacks today do not employ any type checking for UPnP devices, which often leads to improper UPnP device behavior, and security weaknesses in the device implementation. In one embodiment of the present invention, device vendors may use native types to send UPnP events and receive UPnP invocations. UPnP arguments that have an allowed value list may have the value list converted into an enumeration type to enable type checking to be performed. It will be readily apparent to those of ordinary skill in the art that type checking may ensure proper device behavior and enhance the security of the device.

According to one embodiment of the present invention, prior to using a device description document, the document may be edited and tailored to the device vendor's specific device implementation requirements. For example, unsupported actions and events may be removed, and vendor specific information (actions, events, allowed values, etc.) may be added. Since Custom App is easily regenerated, in one embodiment, device vendors may update device descriptions and regenerate Custom Apps as desired. This feature permits easy upgrades and maintenance of Custom Apps.

Embodiments of the present invention may be implemented on a variety of data processing devices. According to embodiment of the present invention, data processing devices are machines that may include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus host controller such as a Universal Serial Bus (“USB”) host controller may be coupled to the bus(es) and a plurality of devices may be coupled to the USB. For example, user input devices such as a keyboard and mouse may be included in the data processing device for providing input data.

In the foregoing specification, embodiments of the invention have been described with reference to specific exemplary embodiments thereof. It will, however, be appreciated that various modifications and changes may be made thereto without departing from the broader spirit and scope of the embodiments of the invention as set forth in the appended claims. The specification and drawings are, accordingly, to be regarded in an illustrative rather than a restrictive sense.

What is claimed is:

1. A method for generating a custom Universal Plug and Play (“UPnP”) application for a device, comprising:
accessing device-specific information for the device;
accessing platform information for the device; and
generating source code based on at least one of the device-specific information and the platform information.

2. The method according to claim 1 further comprising compiling the source code to generate the custom UPnP application.

3. The method according to claim 1 wherein accessing the device-specific information further comprises accessing at least one of a device description and a service description for the device.

4. The method according to claim 2 wherein compiling the source code further comprises compiling the source code based on interface information for the device.

5. The method according to claim 1 wherein generating the source code further comprises optimizing the source code for the device.

6. The method according to claim 1 wherein generating the source code further comprises type checking the source code for the device.

7. An article comprising a machine-accessible medium having stored thereon instructions that, when executed by a machine, cause the machine to generate a custom Universal Plug and Play (“UPnP”) application for a device by:
accessing device-specific information for the device;
accessing platform information for the device; and
generating source code based on at least one of the device-specific information and the platform information.

8. The article according to claim 7 wherein the instructions that, when compiled by the machine, further cause the machine to generate the custom UPnP application for the device by compiling the source code to generate the custom UPnP application.

9. The article according to claim 7 wherein the instructions that, when compiled by the machine, further cause the machine to generate the custom UPnP application by accessing at least one of a device description and a service description for the device.

10. The article according to claim 8 wherein the instructions that, when compiled by the machine, further cause the machine to generate the custom UPnP application for the device by compiling the source code based on at least interface information for the device.

11. The article according to claim 7 wherein the instructions that, when compiled by the machine, further cause the machine to generate the custom UPnP application for the device by optimizing the source code for the device.

12. The article according to claim 7 wherein the instructions that, when compiled by the machine, further cause the machine to generate the custom UPnP application for the device by type checking the source code for the device.

13. An apparatus for generating a custom Universal Plug and Play (“UPnP”) application for a device, comprising:
a processor capable of accessing device-specific information and platform information, and generating source code based on at least one of the device-specific information and the platform information; and
a machine-accessible media coupled to the processor, the machine-accessible media capable of storing the source code.

14. The apparatus according to claim 13 wherein the processor is further capable of compiling the source code to generate the custom UPnP application.

15. The apparatus according to claim 13 wherein the processor is further capable of generating source code based at least one of a device description and a service description for the device.

16. The apparatus according to claim 14 wherein the processor is further capable of compiling the source code based on interface information for the device.

17. The apparatus according to claim 13 wherein the processor is further capable of optimizing the source code for the device.

18. The apparatus according to claim 13 wherein the processor is further capable of type checking the source code for the device.

19. An system for generating a custom Universal Plug and Play (“UPnP”) application for a device, comprising:
a network;
a first processing device coupled to the network, the first processing device capable of accessing device-specific information and platform information and generating source code based on at least one of the device-specific information and the platform information; and
a machine-accessible media coupled to the network, the machine-accessible media capable of receiving and storing the source code.

20. The system according to claim 19 wherein the first processing device is further capable of accessing and compiling the source code to generate the custom UPnP application.

21. The system according to claim 19 further comprising a second processing device coupled to the network, the second processing device capable of accessing and compiling the source code to generate the custom UPnP application.

22. The system according to claim 19 wherein the first processing device is further capable of accessing at least one of a device description and a service description for the device.

23. The system according to claim 21 wherein the second processing device is further capable of compiling the source code based on interface information for the device.

24. The system according to claim 19 wherein the first processing device is further capable of optimizing the source code for the device.

25. The system according to claim 19 wherein the first processing device is further capable of type checking the source code for the device.

26. The system according to claim 20 wherein the first processing device is further capable of compiling the source code based on interface information for the device.
